(19) United States
(12) Patent Application Publication
(10) Pub. No.: US 2026/0158980 A1
(43) Pub. Date: Jun. 11, 2026

(54) VEHICLE CONTROL DEVICE AND METHOD

(71) Applicants: HYUNDAI MOTOR COMPANY, Seoul (KR); KIA CORPORATION, Seoul (KR)

(72) Inventor: Ju Yeong Hong, Hwaseong-si (KR)

(73) Assignees: HYUNDAI MOTOR COMPANY, Seoul (KR); KIA CORPORATION, Seoul (KR)

(21) Appl. No.: 19/226,933

(22) Filed: Jun. 3, 2025

(30) Foreign Application Priority Data
Dec. 11, 2024 (KR) 10-2024-0183312

(51) Int. Cl. B60N 2/90; G10K 11/178

(52) U.S. Cl. CPC B60N 2/90; G10K 11/17823; G10K 11/17881; B60N 2002/981; G10K 11/17825; G10K 2210/12821; G10K 2210/129; G10K 2210/3026; G10K 2210/3027; G10K 2210/501

(57) ABSTRACT

A vehicle control device includes one or more processors and a memory storing computer-readable instructions executable by the one or more processors. The one or more processors are configured to analyze media content playable in a vehicle to determine an impact sound, generate a vibration signal corresponding to the impact sound, and control a vibrator mounted on a vehicle seat based on the vibration signal.

### CROSS-REFERENCE TO RELATED APPLICATION

This application claims priority to and the benefit of Korean Patent Application No. 10-2024-0183312, filed on Dec. 11, 2024, the entire contents of which are hereby incorporated herein by reference.

### BACKGROUND

### 1. Technical Field

The present disclosure relates to a vehicle control device and method.

### 2. Discussion of Related Art

With recent advancements in in-vehicle entertainment systems, technologies that provide various multimedia content such as movies and games are being applied. In particular, technology that provides a four dimensional (4D) effect that allows users to immerse themselves in content by emphasizing low-frequency ranges using a vibrating seat is attracting attention.

However, existing vibration seat-based systems only respond to low-frequency ranges and do not generate appropriate vibration effects in sound effects including high-frequency ranges. This causes problems such as a lack of vibration at time points when an impact should be felt, or conversely, unnecessary vibration at time points when there should be no vibration.

In addition, existing systems operate based on data that stores a time point and intensity of vibration generation for predetermined content. Since the conventional method may only play predefined patterns for specific content, it is difficult to generate vibrations in real time for various content that users want.

In addition, since the conventional method does not reflect a driving state or vibration information within a vehicle, the movement of the vehicle and the effect of a vibration seat are not synchronized, and thus there is a disadvantage in that the immersion is reduced.

### SUMMARY

Embodiments of the present disclosure provide a vehicle control device and method capable of improving the immersion of media content played in a vehicle.

Embodiments of the present disclosure provide a vehicle control device and method capable of reducing external vibration noise transmitted to a vehicle occupant.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a vehicle control device is provided. The vehicle control device includes one or more processors and a memory storing computer-readable instructions executable by the one or more processors. The one or more processors are configured to analyze media content playable in a vehicle to determine an impact sound. The one or more processors are also configured to generate a vibration signal corresponding to the impact sound. The one or more processors are further configured to control a vibrator mounted on a vehicle seat based on the vibration signal.

The one or more processors may be configured to analyze a frequency band of audio data of the media content to determine a section in which energy of the frequency band satisfies a threshold condition as an impact sound section.

The one or more processors may be configured to determine a vibration pattern of the vibration signal based on a duration and repetition cycle of the impact sound.

The one or more processors may be configured to set timing of generation of the vibration signal based on a starting point of the impact sound and set an intensity of the vibration signal based on energy of the impact sound.

The one or more processors may be configured to compensate for the vibration signal based on vehicle driving information generated based on one or more sensor signals.

The one or more processors may be configured to compensate for the vibration signal based on vehicle speed information in the vehicle driving information.

The one or more processors may be configured to compensate for the vibration signal based on a noise signal received from a sensor unit.

The one or more processors may be configured to determine a road surface noise cancellation signal based on a noise signal generated by an audio sensor and a vibration signal generated by an acceleration sensor and compensate for the vibration signal according to the road surface noise cancellation signal.

The one or more processors may compensate for the vibration signal for each seat in the vehicle according to the road surface noise cancellation signal.

The one or more processors may compensate for the vibration signal for each seat road surface noise based on occupant weight information for the seat.

According to another aspect of the present disclosure, a method of controlling a vehicle is provided. The method includes analyzing, by a processor, media content playable in the vehicle and determining an impact sound. The method also includes generating, by the processor, a vibration signal corresponding to the impact sound. The method further includes controlling, by the processor, a vibrator mounted on a vehicle seat based on the vibration signal.

Determining the impact sound may include analyzing a frequency band of audio data of the media content to determine a section in which energy of the frequency band satisfies a threshold condition as an impact sound section.

Generating the vibration signal may include determining a vibration pattern of the vibration signal based on a duration and repetition cycle of the impact sound.

Generating the vibration signal may include setting timing of generation of the vibration signal based on a starting point of the impact sound and setting an intensity of the vibration signal based on energy of the impact sound.

Generating of vibration signal may include compensating for the vibration signal based on vehicle driving information generated based on one or more sensor signals.

Compensating for the vibration signal may include compensating for the vibration signal based on vehicle speed information in the vehicle driving information.

Compensating for the vibration signal may include compensating for the vibration signal based on a noise signal generated based on one or more sensor signals.

Generating the vibration signal may include determining a road surface noise cancellation signal based on a noise signal generated by an audio sensor and a vibration signal generated by an acceleration sensor and compensating for the vibration signal according to the road surface noise cancellation signal.

Generating the vibration signal may include compensating for the vibration signal for each seat in the vehicle according to the cancellation signal.

Generating the vibration signal may include compensating for the vibration signal for each seat in the vehicle based on occupant weight information for the seat.

### BRIEF DESCRIPTION OF THE DRAWINGS

The above and other objects, features, and advantages of the present disclosure should become more apparent to those of ordinary skill in the art from the following detailed description taken in conjunction with the accompanying drawings, in which:

FIG. 1 is a view showing a vehicle transmitting and receiving data by communicating with other devices, according to an embodiment of the present disclosure;

FIG. 2 is a diagram showing modules of a vehicle according to an embodiment of the present disclosure;

FIG. 3 is a view for describing the operation of a vibrator according to an embodiment;

FIG. 4 is a block diagram of components of a vehicle control device according to an embodiment;

FIG. 5 is a diagram for describing the operation of a vehicle control device according to an embodiment;

FIG. 6 is a diagram for describing the operation of a second processing unit according to an embodiment; and

FIG. 7 is a flowchart of a method of controlling a vehicle according to an embodiment.

### DETAILED DESCRIPTION

Hereinafter, embodiments of the present disclosure are described in detail with reference to the accompanying drawings.

However, the technical idea of the present disclosure is not limited to the described embodiments. Rather, the present disclosure may be implemented in various different forms. For example, within the scope of the technical idea of the present disclosure, one or more components in the described embodiments may be selectively combined and/or substituted.

Further, unless specifically defined and described herein, terms used in the following description (including technical and scientific terms) should be interpreted as having meanings generally understood by those having ordinary skill in the art to which the present disclosure pertains, and commonly used terms such as terms defined in dictionaries should be interpreted in consideration of the contextual meaning of the related art.

The terms used in the following description are for the purpose of describing the embodiments only and are not intended to limit the present disclosure.

In the present specification, the singular forms may include the plural forms unless the context clearly dictates otherwise, and when described as “at least one (or one or more) among A, B, and (or) C,” it may include one or more of all possible combinations of A, B, and/or C.

In addition, when describing components of embodiments of the present disclosure, terms such as first, second, A, B, (a), (b), etc., may be used. These terms are only for distinguishing the components from other components, and the essence, sequence, or order of the components is not limited by these terms.

In addition, when a component is described as being “linked,” “coupled,” or “connected” to or with another component, the component is not necessarily directly linked, coupled, or connected to or with another component, but may also be “linked,” “coupled,” or “connected” to or with another component with one or more still other components disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings. In the following description, the same or corresponding components are denoted by the same reference numerals regardless of the drawing numbers, and redundant descriptions thereof are omitted.

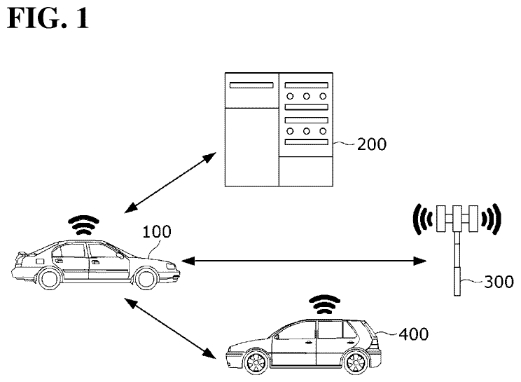

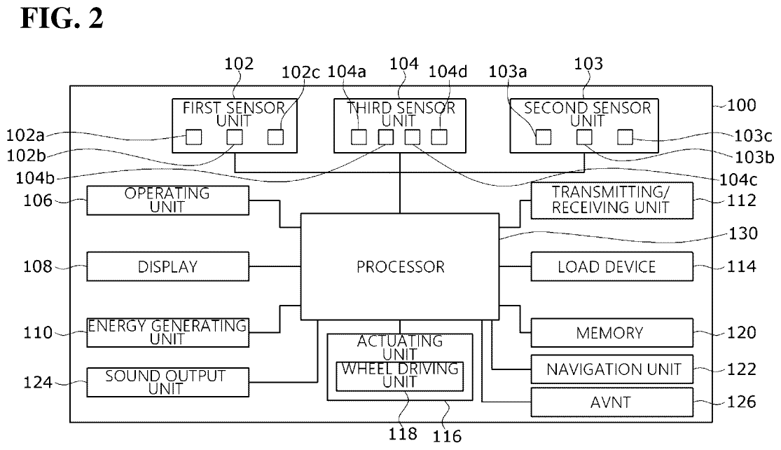

Hereinafter, a vehicle according to an embodiment is described with reference to FIGS. 1 and 2. FIG. 1 is a view illustrating a vehicle transmitting and receiving data by communicating with other devices, according to an embodiment.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy. The vehicle 100 may be filled with gas in a liquefied state, for example. One example of the gas may be hydrogen. However, the gas is not limited thereto, and various gases are applicable. In the case of fossil energy, the vehicle 100 is driven based on fuel such as gasoline, diesel or liquefied gas, and may be equipped with an internal combustion engine that drives an actuating unit (e.g., actuating unit 116 of FIG. 2) by combustion of the fuel. The engine may be included in an energy generating unit (e.g., engine generating unit 110 of FIG. 2) in terms of providing a driving rotational force of wheels to a wheel driving unit (e.g., a wheel driving unit 118 of FIG. 2). As another example, the vehicle 100 may drive the actuating unit by selectively utilizing energy from a fossil energy-based internal combustion engine and an electric battery, and may be a hybrid type vehicle.

The vehicle 100 may refer to a movable device. The vehicle 100 may be a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but unless it contradicts the present disclosure, the present embodiment may also be applied to air mobility devices such as AAMs, aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor (e.g., processor 130 of FIG. 2) of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1-4, and the fully autonomous driving may correspond to level 5.

The vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 and/or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data through vehicle-to-vehicle (V2V) communication with the other vehicle 400.

The vehicle 100 may communicate with other vehicles and/or other devices based on cellular communication, wireless access in vehicular environment (WAVE) communication, dedicated short range communication (DSRC), short-range communication, or other communication methods.

For example, the vehicle 100 may use a cellular communication network such as Long Term Evolution (LTE) or 5G, a WiFi communication network, a WAVE communication network, or the like, for communication with the server 200, the ITS device 300, and the other vehicle 400. For another example, Direct Short Range Communication (DSRC) or the like used in the vehicle 100 may be used for communication between vehicles. The communication method between the vehicle 100, the server 200, the ITS device 300, the other vehicle 400, and the user device is not limited to the above-described examples.

FIG. 2 is a diagram showing modules of the vehicle 100 of FIG. 1, according to one embodiment of the present disclosure.

The vehicle 100 may include a first sensor unit 102, a second sensor unit 103, a third sensor unit 104, an operating unit 106, a display 108, a load device 114, and a transmitting/receiving unit 112.

The sensor units 102, 103, and 104 may be provided with various types of detectors to detect various states and situations occurring in an external environment, an internal system, user operation, and a boarding space of the vehicle 100. The vehicle 100 may also include a memory 102 and the processor 130. In addition, the vehicle 100 may include the energy generating unit 110 and the actuating unit 116.

The first sensor unit 102 may be provided with an externally oriented camera 102a, a LiDAR sensor 102b, a radar sensor 102c, and/or the like, to recognize dynamic and static objects present outside the vehicle 100. The camera 102a may recognize an external object as an image while the vehicle 100 is in use, generate image data, and transmit the image data to the processor 130. The lidar sensor 102b may generate point cloud data as recognized data of the external object and transmit the point cloud data to the processor 130 to generate three dimensional (3D) spatial information that identifies at least a shape of the external object. In order to ascertain the presence of an external object and its relative distance, speed, direction, or the like, the radar sensor 102c may emit radio waves of a specific frequency around the vehicle 100 and generate radar data through radio waves reflected from the external object. In the present disclosure, the sensor unit is illustrated as having the lidar sensor 102b, but in other examples, the lidar sensor 102b may not be mounted.

The first sensor unit 102 may generate object recognition information based on sensing data. The object recognition information may include information on the presence of an object, position information about the object, information on a distance between the vehicle 100 and the object, and information on a relative speed between the vehicle 100 and the object. In the embodiment, external objects may be various objects related to the operation of the vehicle 100.

The second sensor unit 103 may be provided with a positioning sensor 103a, a wheel sensor 103b, an attitude sensor 103c, and the like, to confirm its own location, speed, driving attitude, and/or the like. The attitude sensor 103c may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle driving information may include route information. The route information may refer to information generated based on a destination input by a vehicle user through the operating unit 106. The route information may refer to information that indicates a traveling route from a current position of a host vehicle to a destination on a map when the destination has been set. When no destination is set, the route information may refer to information including a road on which the host vehicle is currently traveling and a future driving route including the road.

The third sensor unit 105 may include an audio (e.g., voice) sensor 104a that collects audio (e.g., voice) signals inside the vehicle, a vibration sensor 104b disposed around the occupant, a camera 104c that captures the inside of the vehicle, and a pressure sensor 104d.

The audio sensor 104a may include at least one microphone disposed inside the vehicle, and may collect voices and humming sounds expressed by the occupant inside the vehicle to generate a voice signal. In addition, the audio sensor 104a may collect road surface noise transmitted inside the vehicle to generate a noise signal.

The vibration sensor 104b may include at least one acceleration sensor or gyro sensor disposed at a position where the occupant's body may touch, and may generate a vibration signal by measuring the vibrations generated when a steering wheel, a console box, or a dashboard is tapped on inside the vehicle.

The camera 104c may capture the inside of the vehicle. The camera 104c may be disposed to face the front of the upper body of the occupant, thereby generating a video signal by capturing the movements of the occupant.

The pressure sensor 104d may be disposed on the vehicle seat to detect the pressure applied to the vehicle seat. A plurality of pressure sensors 104d may be disposed on a backrest and a seat bottom of the vehicle seat. The pressure sensor 104d may convert the pressure applied to the vehicle seat into an electrical signal to generate a pressure signal.

The operating unit 106 may be configured as a module that is controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that may be touched on the display 108. Depending on the specifications of the autonomous vehicle, at least one of the steering wheel, the transmission, and the pedal may be omitted. As another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting a driver's input to receive a driver's request to instruct the processor 130.

The load device 114 may be mounted on the vehicle 100 and may be a type of non-driving electrical device excluding a driving power system such as the wheel driving unit 118 or the like. The load device 114 may be an auxiliary device that receives electrical power from the energy generating unit 110, and may be, for example, an air conditioning system, a lighting system, a seat system, various devices installed in the vehicle 100, or the like. In the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, nearby vehicles 300, and/or the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In embodiments of the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and may provide the traffic signal information to the processor 130. In addition, the transmitting/receiving unit 112 may receive a control signal from the traffic signal controller and may provide the control signal to the processor 130.

The energy generating unit 110 may generate and supply power and electric power used in a driving power system and a non-driving power system, such as the actuating unit 116. The non-driving power system may include, for example, the sensor unit 102, the operating unit 106, the display 108, the load device 114, and the transmitting/receiving unit 112, but is not limited thereto, and may include various components that implement sensing, interface, communication, and convenience functions, excluding components directly involved in driving operations. When the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as an internal combustion engine. In addition, when the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit 122 may provide navigation information. The navigation information may include at least one of map information, set destination information, route information according to a set destination, information on various objects on the route, lane information, or current vehicle position information.

The navigation unit 122 may receive information from an external device through the transmitting/receiving unit 112 and update previously stored information. According to an embodiment, the navigation unit 122 may be classified as a sub-component of the operating unit 106.

A sound output unit 124 may convert an electrical signal provided from the processor 130 into audio data and output the audio data. The sound output unit 124 may include one or more speakers.

The processor 130 may control the operation of the speaker and may generate sound signals in conjunction with various systems of the vehicle. The processor 130 may adjust sounds output depending on the vehicle speed, ambient noise, and/or traffic conditions.

The processor 130 may be connected to a controller area network bus (CAN) system of the vehicle, and may transmit sound signals to the speaker.

The memory 120 may store applications and various types of data for controlling the vehicle 100, and load applications or read and record data by a request of the processor 130.

The processor 130 may perform overall control of the vehicle 100. The processor 130 may be configured to execute applications and instructions stored in the memory 120.

The audio/video/navigation/telecommunication (AVNT) 126 is a term referring to an information and entertainment system in the vehicle, and may refer to a system that integrates navigation, audio, video, and communication functions. The AVNT 126 may output a message generated by the processor 130 in at least one of a visual manner, an audible manner, or a combination thereof.

The AVNT 126 may refer to a component that provides a hardware interface integrated into the system in the vehicle. The AVNT 126 may perform system control targeting screens, buttons and various integrated information and entertainment functions.

The AVNT 126 may be installed in a center or console of the vehicle dashboard and may provide vehicle information and an entertainment interface. The information and entertainment system may include AM/FM radio, satellite radio, DVDs/CDs, cassette tapes, USB MP3, dashcams, GPS navigation, Bluetooth, Wi-Fi, and the like, and may also provide state information on the vehicle system. In addition, the AVNT 126 may perform functions such as speech control, motion recognition, and the like.

The AVNT 126 may be configured to include a microphone, the sound output unit 124, and the processor 130, but for convenience of description, each configuration is separately described.

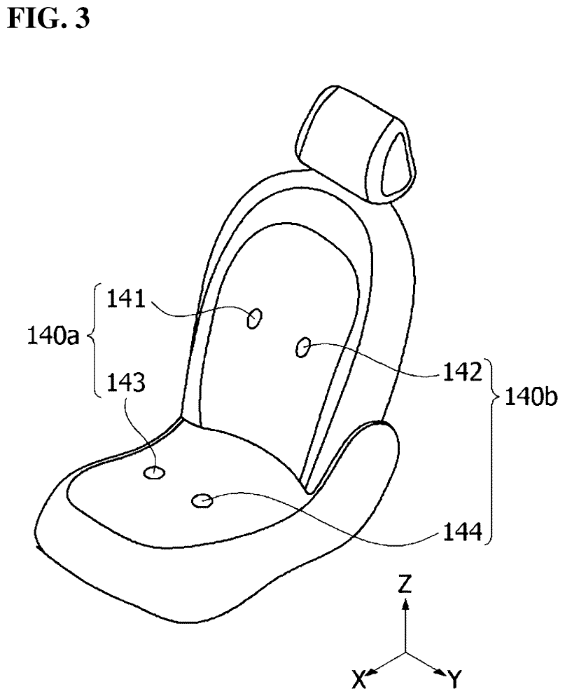

FIG. 3 is a view for describing the operation of a vibrator 140 according to an embodiment. Referring to FIG. 3, the vibrator 140 may be provided on a back rest and a seat bottom of a seat and may independently output a vibration signal. The vibrator 140 may be disposed to be embedded in an empty space of the back rest and the seat bottom of the seat. In an embodiment, the vibrator 140 may include multiple vibrators (sometimes referred to herein as simply vibrator 140 for ease of explanation). For example, the vibrator 104 may include two vibrators 141 and 142 disposed on the back rest and two vibrators 143 and 144 disposed on the seat bottom at predetermined intervals. Each of the vibrators 141-144 may operate independently under the control of the processor 130 and may output a predetermined vibration signal.

Each vibrator 140 may be provided in a form that includes a frame forming an exterior, a voice coil installed inside the frame that forms a magnetic field when an electrical signal is applied, at least one magnet that vibrates with a certain frequency by interacting with the magnetic field of the voice coil, a vibrating body that transmits vibration of the magnet to the human body, and/or the like. When an electrical signal is applied to the voice coil of the vibrator 140 according to the control of the processor, a magnetic field proportional to the intensity of the electrical signal is formed in the voice coil, and as the magnetic field interacts with the magnet, the magnet vibrates in an up-and-down direction at a predetermined frequency. As the vibration signal is output through the vibrating body and transmitted to the human body, the human body recognizes a predetermined acoustic signal.

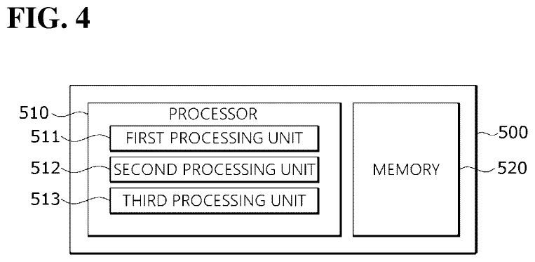

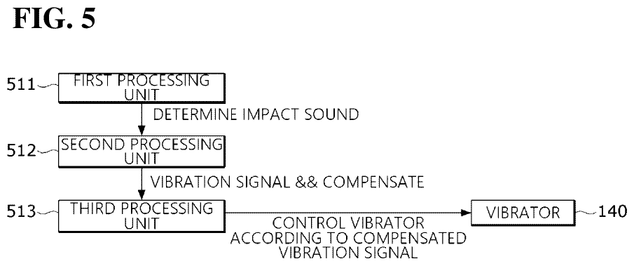

FIG. 4 is a block diagram of components of a vehicle control device according to an embodiment. FIG. 5 is a diagram for describing the operation of a vehicle control device according to an embodiment. Referring to FIGS. 4 and 5, a vehicle control device 500 according to an embodiment may include a processor 510 and a memory 520. The processor 510 and the memory 520 of the vehicle control device 500 may have the same configuration as the processor 310 and the memory 320 in FIG. 2. In addition, the vehicle control device 500 may perform data communication with components installed in the vehicle through CAN communication.

The processor 510 may include a first processing unit 511, a second processing unit 512, and a third processing unit 513.

The first processing unit 511 may analyze media content that may be played in the vehicle to determine an impact sound. In an embodiment, the media content may include audio data. The media content may refer to any content that may be played in the vehicle, such as movies, music, games, and/or the like.

The first processing unit 511 may analyze a frequency band of audio data of media content and may determine a section in which the energy of the frequency band satisfies a threshold condition. For example, the first processing unit 511 may analyze a frequency band of audio data of media content and may determine a section in which the energy of the frequency band is equal to or greater than a preset threshold value as an impact sound section.

The impact sound in audio data (e.g., sound of explosion, crashes) usually has a short, strong energy peak and exhibits distinct characteristics in a specific frequency band. The first processing unit 511 may analyze and extract an impact sound by converting audio data of media content into a frequency domain using a fast Fourier transform (FFT).

The first processing unit 511 may analyze audio data of media content by dividing the audio data of media content into a certain length (e.g., 2048 or 4096 samples) by applying a window function (e.g., Hamming window).

The first processing unit 511 may convert time domain data to frequency domain data by applying a fast Fourier transform to each window.

The first processing unit 511 may determine a total energy of a spectrum of the audio data converted to a frequency signal or the energy of a specific frequency band.

The first processing unit 511 may set a threshold value for determining an impact sound based on the analyzed energy or change rate value.

The first processing unit 511 may determine a section in which the energy of the frequency band is equal to or greater than a preset threshold value as the impact sound section.

The first processing unit 511 may determine an actual location of a time axis using a start time and sample length of the fast Fourier transform window for the impact sound section, and may record or visualize (e.g., spectrogram) an occurrence time and characteristics of the impact sound.

Alternatively, the first processing unit 511 may separately store the impact sound in the memory 520.

The second processing unit 512 may generate a vibration signal corresponding to the impact sound effect. The second processing unit 512 may determine a vibration pattern of the vibration signal based on the duration and repetition cycle of the impact sound.

For example, the second processing unit 512 may set the timing of generation of the vibration signal based on a starting point of the impact sound and may set the intensity of the vibration signal based on the energy of the impact sound.

The second processing unit 512 may take the impact sound analyzed through the first processing unit 511 as input data and may analyze the frequency and time characteristics. The second processing unit 512 may analyze the frequency band and duration of the impact sound to check whether strong energy is concentrated in a specific frequency band or distributed over a wide band.

The second processing unit 512 may map the characteristics of the impact sound into a signal of a vibration motor. The second processing unit 512 may set the timing of generation of the vibration signal based on the starting point of the impact sound and convert a sampling rate of audio data into a control cycle of the vibration signal for synchronization.

The second processing unit 512 may convert the energy of the impact sound into vibration intensity (amplitude). The second processing unit 512 may normalize an energy magnitude of the impact sound to an output range of the vibrator (e.g., 0 to 100%) and may set the vibration intensity in proportion to the energy size.

The second processing unit 512 may generate the vibration pattern of a vibration signal based on the duration and repetition cycle of the impact sound. For example, the second processing unit 512 may map a short single vibration in a section where a short impact sound occurs and may map a vibration pattern that repeats at a specific interval in a section where repetitive impact sounds occur.

In addition, the second processing unit 512 may adjust the frequency of the vibrator using the frequency band information about the impact sound. For example, the second processing unit 512 may set the frequency to slow vibration based on determining that the frequency band of the impact sound is a low frequency and may set the frequency to fast vibration based on determining that the frequency band is a high frequency.

Based on the analyzed data, the second processing unit 512 may generate a vibration signal for controlling the vibrator. The vibration signal may be generated as a pulse width modulation (PWM) signal.

The second processing unit 512 may compensate for the vibration signal using the vehicle driving information received from a sensor unit. In an embodiment, the sensor unit may be the second sensor unit 103 of FIG. 2. In an embodiment, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and/or the like.

In addition, the second processing unit 512 may receive sensor information from the third sensor unit 104 of FIG. 2. For example, the second processing unit 512 may receive a noise signal collected from road surface noise transmitted inside the vehicle through the audio sensor 104a.

In an example, the second processing unit 512 may compensate for the vibration signal using vehicle speed information in vehicle driving information. The second processing unit 512 may compensate for the vibration signal so that the vibration intensity increases in proportion to the speed of the vehicle.

As another example, the second processing unit 512 may compensate for the vibration signal using a noise signal received from the sensor unit. The second processing unit 512 may compensate for the vibration signal so that the vibration intensity increases in proportion to the noise signal.

As yet another example, the second processing unit 512 may compensate for the vibration signal using the vehicle speed information and the noise signal. For example, the second processing unit 512 may compensate for the vibration signal so that the intensity of the vibration signal increases when the speed of the vehicle is high and the noise signal is large. As another example, the second processing unit 512 may compensate for the vibration signal so that the intensity of the vibration signal decreases when the speed of the vehicle is low and the noise signal is small.

The second processing unit 512 may compensate for the vibration signal in real time when the speed of the vehicle or the magnitude of the noise signal changes. For example, the second processing unit 512 may compensate for the vibration signal so that the vibration intensity increases when the speed of the vehicle increases when entering a smooth road while traveling at high speed.

Alternatively, the second processing unit 512 may compensate for the vibration signal so that the vibration intensity increases when the vehicle enters an unpaved road while maintaining low-speed driving and the noise signal increases.

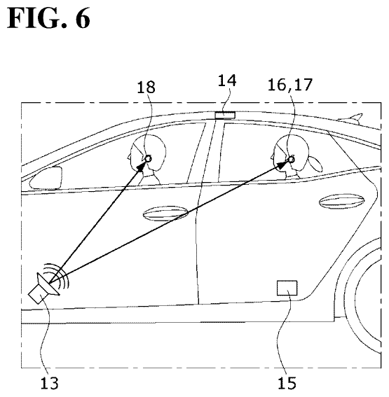

FIG. 6 is a diagram for describing the operation of the second processing unit 512 according to the embodiment. Referring to FIG. 6, the second processing unit 512 may use a road noise signal received from a microphone 14 and a vibration signal of an acceleration sensor 15 to determine a road surface noise cancellation signal. The second processing unit 512 may compensate for the vibration signal according to the cancellation signal.

The microphone 14 may be installed inside the vehicle and detect the road noise signal. In the embodiment, the road noise signal may refer to ambient noise generated due to the interaction between the road and tires during vehicle traveling, a surrounding environment, and/or the structural characteristics of the vehicle itself. The road noise signal may include tire-to-road surface contact noise, aerodynamic noise, engine and exhaust system noise, and/or structural vibration noise of the vehicle.

The microphone 14 may be mounted inside the vehicle. The microphone 14 may receive a voice signal, the road noise signal, and a media output signal detected inside the vehicle. The microphone 14 may be installed in various locations inside the vehicle to receive these acoustic signals as clearly as possible.

For example, the microphone 14 may be mounted in a headliner portion of the vehicle. The location may be close to the mouth of the occupant to receive speech efficiently and receive relatively less ambient noise (e.g., wind noise coming in through the window).

As another example, the microphone 14 may be mounted on or near a rearview mirror to collect the speech of the occupant.

For example, the microphone 14 may be disposed in a manner of being integrated into the AVNT of the dashboard.

The microphone 14 may comprise a single microphone 14, a dual microphone 14, or multiple microphones 14.

The single microphone 14 may receive the speech of the driver using only one microphone 14 in the vehicle.

The dual microphone 14 may provide better noise suppression and echo cancellation performance using two microphones. The dual microphone 14 may be used so that one microphone 14 may collect speech of the occupant and the other may collect ambient noise, and may then compare the speeches and the noise to remove the noise and extract the speech.

The multiple microphones 14 may use an array of multiple microphones 14 to enhance the directionality of sound and selectively receive only the speech coming from a specific direction through beamforming technology.

The acceleration sensor 15 may be installed in the vehicle to measure the vibration signal. The acceleration sensor 15 may detect vibration occurring in a vehicle body, an engine mount, a suspension system, and/or the like, of the vehicle. For example, the acceleration sensor 15 may be installed around the engine mount of the vehicle to monitor the vibration generated from the engine in real time. As another example, the acceleration sensor 15 may be installed on a vehicle body frame and a subframe to detect contact vibration between the tire and the road. As yet example, the acceleration sensor 15 may be installed on a floor of the vehicle to monitor the vibration transmitted to the entire vehicle body. As still another example, the acceleration sensor 15 may be installed in a trunk and a rear subframe to detect the vibration occurring at the rear of the vehicle. For example, the acceleration sensor 15 may be installed in an A-pillar, B-pillar, and/or the like, to monitor structural vibration of the entire vehicle.

In an embodiment, at least one acceleration sensor 15 may be disposed according to a vehicle model, size, and design structure to detect vibrations occurring in various regions of the vehicle and to generate the vibration signal.

Error microphones 16 and 17 may be installed inside the vehicle, especially near a head or ear position of an occupant for each seat, to measure the noise actually heard by the occupant. The error microphones 16 and 17 may detect residual noise introduced into the vehicle to monitor levels of various noises including road surface noise, engine noise, wind noise, and/or the like.

For example, the error microphones 16 and 17 may be disposed on a headrest of a front seat of the vehicle and a headrest of a rear seat of the vehicle, respectively.

When a noise cancellation signal (anti-noise) is output through a speaker 13 in the second processing unit 512, each of the error microphones 16 and 17 may check how effectively this signal works inside the vehicle.

The second processing unit 512 according to an embodiment may generate the cancellation signal to reduce road surface noise by applying an active noise control for road (ANC-R) system utilizing the acceleration sensor 15. The second processing unit 512 may use the vibration signal of the acceleration sensor 15 as a reference signal to effectively reduce low-frequency noise generated from the floor of the vehicle using the filtered-x least mean square (FxLMS) algorithm.

The second processing unit 512 may generate error information based on the road noise signal and vibration signal, and may generate a cancellation signal corresponding to the vibration signal using a filter updated according to the error information.

The second processing unit 512 may determine error information for each seat according to an acoustic path from when the cancellation signal is input to an amplifier of the vehicle to when the cancellation signal reaches the error microphone 16 or the error microphone 17 for each seat.

The second processing unit 512 may reflect the cancellation signal to the road noise signal to determine a sound wave compensation signal.

The reference signal input from the acceleration sensor 15 may pass through the acoustic path for each seat to reflect frequency characteristics inside the vehicle. In an embodiment, the acoustic path may include or be composed of the second processing unit 512, the speaker 13, and the error microphone 16 or the error microphone 17 for each seat in that order.

$$\hat{x} ( n ) = \hat{S} ( z ) * x ( n ) \qquad [ Equation 1 ]$$

In Equation 1, Ŝ(z) is a function that models frequency transfer characteristics of an acoustic path, x(n) is a reference signal, and \hat{x}(n) is an estimated reference signal that reflects the frequency transfer characteristics of the acoustic path.

The second processing unit 512 may generate a reference signal that estimates a degree of reflection of frequency characteristics inside the vehicle using a vibration signal as the reference signal as in Equation 1. The second processing unit 512 may generate a signal that estimates a vibration signal transmitted through an acoustic path for each seat.

The second processing unit 512 may adjust a weight based on a reference signal estimated to cancel road noise using a filter according to Equation 2 below.

$$W ( n + 1 ) = W ( n ) + μ e ( n ) \hat{x} ( n ) \qquad [ Equation 2 ]$$

In Equation 2, W(n) is a filter, W(n+1) is an updated filter, μ is a learning rate, and e(n) is residual noise measured from the error microphones 16 and 17, and may refer to error information. The filter may be an adaptive filter and may be updated based on the error information.

The second processing unit 512 may generate a cancellation signal by passing the vibration signal detected by the acceleration sensor 15 through the updated filter using it as the reference signal. The second processing unit 512 may generate a cancellation signal according to Equation 3 below.

$$y ( n ) = W ( z ) * x ( n ) \qquad [ Equation 3 ]$$

In Equation 3, y(n) is a cancellation signal, W(z) is an updated filter, and x(n) is a vibration signal.

The second processing unit 512 may output the cancellation signal through the speaker 13 and measure the residual noise using the signal input to the error microphones 16 and 17.

The error information may be defined according to Equation 4 below.

$$e ( n ) = d ( n ) - y ( n ) \qquad [ Equation 4 ]$$

In Equation 4, e(n) is error information, d(n) is a sound wave signal measured through the microphone 14, and y(n) is a cancellation signal. The error information may be used to adaptively update the filter. The second processing unit 512 may repeat the process of determining the aforementioned cancellation signal and updating the filter using the cancellation signal and error information, thereby implementing a filter that may respond to various road conditions (e.g., paved road, unpaved road, or the like) in real time.

The second processing unit 512 may compensate for the vibration signal for each seat according to the cancellation signal. The second processing unit 512 may compensate for the vibration signal using the cancellation signal determined for each seat. The cancellation signal may refer to a signal for cancelling the road surface noise signal transmitted to each seat. Accordingly, the second processing unit 512 may compensate for the vibration signal so that the vibration intensity increases in proportion to the magnitude of the cancellation signal for each seat. The second processing unit 512 may generate a vibration signal for each seat and transmit the generated vibration signal to the third processing unit 513.

The second processing unit 512 may compensate for the vibration signal for each seat based on weight information about an occupant received from a sensor unit in each seat. In an embodiment, the sensor unit may refer to the pressure sensor in FIG. 2. The second processing unit 512 may estimate the weight of the occupant using a pressure signal detected by the pressure sensor for each seat. The second processing unit 512 may compensate for the vibration signal for each seat so that the vibration intensity increases in proportion to the estimated weight information about the occupant.

The third processing unit 513 may control the vibrator 140 mounted on the vehicle seat using the vibration signal. The third processing unit 513 may independently control the movement of the vibrator 140 of the corresponding seat using the vibration signal generated by the second processing unit 512 for each seat.

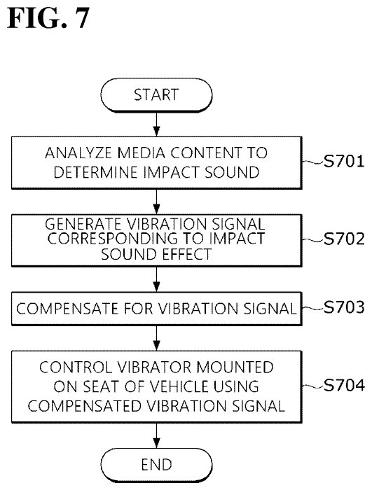

FIG. 7 is a flowchart of a method of controlling a vehicle according to an embodiment. Referring to FIG. 7, in an operation S701, a processor analyzes media content playable within the vehicle to determine an impact sound. The processor may analyze a frequency band of audio data of media content and determine a section in which the energy of the frequency band satisfies a threshold condition (e.g., is equal to or greater than a preset threshold value) as an impact sound section.

In an operation S702, the processor generates a vibration signal corresponding to the impact sound effect. The processor may convert the energy of the impact sound into vibration intensity (amplitude) and generate a vibration pattern of the vibration signal based on a duration and repetition cycle of the impact sound. In addition, the processor may adjust a frequency of the vibrator using frequency band information about the impact sound.

In an operation S703, the processor compensates for the vibration signal. For example, the processor may compensate for the vibration signal using at least one of speed information about the vehicle and a noise signal. As another example, the processor may use a road noise signal received from a microphone and a vibration signal of an acceleration sensor to determine a road surface noise cancellation signal, and compensate for the vibration signal according to the cancellation signal. As yet another example, the processor may compensate for the vibration signal for each seat based on weight information about an occupant for each seat.

In an operation S704, the processor uses the compensated vibration signal to control the vibrator mounted on the seat of the vehicle. The processor may independently control the operation of the corresponding seat vibrator using the vibration signal for each seat.

The term “˜unit” used in the present disclosure may refer to software components or hardware components such as a field-programmable gate array (FPGA) or an application specific integrated circuit (ASIC), and “˜unit” performs certain functions. However, the “˜unit” is not limited to software or hardware. The “˜unit” may be configured to reside in an addressable storage medium, or may be configured to reproduce one or more processors. Therefore, for example, “˜unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “˜unit” may be combined into smaller numbers of components and “˜units,” or may be further divided into additional components and “˜units.” Furthermore, the components and “˜units” may be implemented to reproduce one or more CPUs in a device or a security multimedia card.

With a vehicle control device and method according to an embodiment, it is possible to improve the immersion of media content played in a vehicle.

In addition, it is possible to reduce external vibration noise transmitted to a vehicle occupant.

In addition, by applying a dynamic compensation algorithm that considers a speed of the vehicle and road vibration information during a process of controlling a vibration seat, it is possible to reflect a vehicle driving state in real time.

Although example embodiments of the present disclosure have been described above, it should be understood by those having ordinary skill in the art to which the present disclosure pertains that various changes and modifications to the present disclosure may be made without departing from the spirit and scope of the present disclosure set forth in the appended claims.

What is claimed is:

1. A vehicle control device comprising:
one or more processors; and
a memory storing computer-readable instructions executable by the one or more processors,
wherein the one or more processors are configured to:
analyze media content playable in a vehicle to determine an impact sound;
generate a vibration signal corresponding to the impact sound; and
control a vibrator mounted on a vehicle seat based on the vibration signal.

2. The vehicle control device of claim 1, wherein the one or more processors are configured to analyze a frequency band of audio data of the media content to determine a section in which energy of the frequency band satisfies a threshold condition as an impact sound section.

3. The vehicle control device of claim 1, wherein the one or more processors are configured to determine a vibration pattern of the vibration signal based on a duration and repetition cycle of the impact sound.

4. The vehicle control device of claim 3, wherein the one or more processors are configured to:
set timing of generation of the vibration signal based on a starting point of the impact sound; and
set an intensity of the vibration signal based on energy of the impact sound.

5. The vehicle control device of claim 1, wherein the one or more processors are configured to compensate for the vibration signal based on vehicle driving information generated based on one or more sensor signals.

6. The vehicle control device of claim 5, wherein the one or more processors are configured to compensate for the vibration signal based on vehicle speed information in the vehicle driving information.

7. The vehicle control device of claim 1, wherein the one or more processors are configured to compensate for the vibration signal based on a noise signal generated by an audio sensor.

8. The vehicle control device of claim 1, wherein the one or more processors are configured to:
determine a road surface noise cancellation signal based on a noise signal generated by an audio sensor and a vibration signal generated by an acceleration sensor; and
compensate for the vibration signal according to the road surface noise cancellation signal.

9. The vehicle control device of claim 8, wherein the one or more processors are configured to compensate for the vibration signal for each seat in the vehicle according to the road surface noise cancellation signal.

10. The vehicle control device of claim 1, wherein the one or more processors are configured to compensate for the vibration signal for each seat in the vehicle based on occupant weight information the seat.

11. A method of controlling a vehicle, the method comprising:
analyzing, by a processor, media content playable in the vehicle and determining an impact sound;
generating, by the processor, a vibration signal corresponding to the impact sound; and
controlling, by the processor, a vibrator mounted on a vehicle seat based on the vibration signal.

12. The method of claim 11, wherein determining the impact sound includes analyzing a frequency band of audio data of the media content to determine a section in which energy of the frequency band satisfies a preset threshold condition as an impact sound section.

13. The method of claim 11, wherein generating the vibration signal includes determining a vibration pattern of the vibration signal based on a duration and repetition cycle of the impact sound.

14. The method of claim 13, wherein generating the vibration signal includes:
setting timing of generation of the vibration signal based on a starting point of the impact sound; and
setting an intensity of the vibration signal based on energy of the impact sound.

15. The method of claim 11, wherein generating the vibration signal includes compensating for the vibration signal based on vehicle driving information generated based on one or more sensor signals.

16. The method of claim 15, wherein compensating for the vibration signal includes compensating for the vibration signal based on vehicle speed information in the vehicle driving information.

17. The method of claim 11, wherein compensating for the vibration signal includes compensating for the vibration signal based on a noise signal generated by an audio sensor.

18. The method of claim 11, wherein generating the vibration signal includes:
determining a road surface noise cancellation signal based on a noise signal received generated by an audio sensor and a vibration signal generated by an acceleration sensor; and
compensating for the vibration signal according to the road surface noise cancellation signal.

19. The method of claim 18, wherein generating the vibration signal includes compensating for the vibration signal for each seat in the vehicle according to the road surface noise cancellation signal.

20. The method of claim 11, wherein generating the vibration signal includes compensating for the vibration signal for each seat in the vehicle based on occupant weight information for the seat.
